(19) United States
(12) Patent Application Publication
(10) Pub. No.: US 2015/0161621 A1
(43) Pub. Date: Jun. 11, 2015

(54) METHOD AND APPARATUS FOR VERIFYING SECURITY SYSTEM INSTALLATIONS

(71) Applicant: Kurt W. Becker, West Palm Beach, FL (US)

(72) Inventor: Kurt W. Becker, West Palm Beach, FL (US)

(21) Appl. No.: 14/102,003

(22) Filed: Dec. 10, 2013

(51) Int. Cl. G06Q 30/00

(52) U.S. Cl. CPC G06Q 30/0185

(57) ABSTRACT

A method and apparatus for verifying a security system installations. In one embodiment, a method comprises creating a customer account record, receiving a security panel identification of a security panel and a physical address where the security panel has been installed, storing the physical address and the security panel identification in the customer account record, receiving identification information and a current location of the security panel as determined by location circuitry resident within the security panel over a communication channel used to transmit alarm event information by the security panel, comparing the current location of the security panel to the physical address stored in the customer account to determine whether the current location of the security panel is within a predetermined distance of the physical address, and providing an indication of the result of the comparison.

### BACKGROUND

I. Field of Use

The present application relates to the home security market. More specifically, the present application relates to a method and apparatus for verifying security system contracts.

II. Description of the Related Art

The home security business has enjoyed widespread popularity over the years.

Customers typically engage professional security system companies to install security system components to protect against break-ins, fire, carbon monoxide, or other emergency situations. Such systems typically comprise a plurality of sensors, such as door/window contacts, motion detectors, smoke detectors, etc. that communicate with a central panel mounted in a convenient location. Customers may elect to have their security system monitored by a remote, third party monitoring service, such as ADT, Diebold, and many others. When an emergency is detected by one or more of the sensors, the central panel is notified and, in turn, transmits a signal to the remote monitoring center indicative of the emergency condition. The remote monitoring center receives the signal transmitted by the central panel and may take one or more actions, such as place a telephone call to the origination of the signal to verify the emergency condition, or alert authorities such as fire, police, ambulance, etc.

Customers who choose to have their security systems monitored by a remote monitoring service typically sign a service contract with the professional installer who installed the security system. Over time, the professional installer may have hundreds of homeowners under contract to provide security monitoring services. It is not uncommon in the industry for such professional installers to bundle and sell these accounts to a third party, such as remote monitoring companies, as the contracts represent a monthly revenue stream.

One problem for buyers of such contracts is the prevalence of fraud within the industry. For example, a seller of contracts may represent that he has 300 active monitoring contracts for sale, while in reality, a number of those accounts are fraudulent and do not exist. Purchasers of such contracts try to ensure that each contract is valid, typically by calling a phone number associated with the account to try and speak with the actual homeowner. However, sophisticated sellers of these monitoring contracts may route such calls to an accomplice, who falsely verifies the contract with the contract purchaser. The result is that the buyer of such contracts often over-pays for accounts that do not actually exist.

Therefore, it would be desirable for monitoring contract purchasers to be able to determine whether the accounts that they are purchasing are actually valid accounts.

### SUMMARY

The embodiments described herein relate to a method and apparatus for verifying a location of a security panel installation. In one embodiment, a method is described, comprising creating a customer account record by a processor in a memory, receiving a security panel identification of a security panel and a physical address where the security panel has been installed, storing the physical address and the security panel identification in the customer account record, receiving a message from the security panel over a communication channel used to transmit alarm event information by the security panel, the message comprising identification information of the security panel sending the message and a current location of the security panel as determined by location circuitry resident within the security panel, comparing the current location of the security panel to the physical address stored in the customer account by the processor to determine whether the current location of the security panel is within a predetermined distance of the physical address, and providing an indication of the result of the comparison of whether the current location of the security panel is within the predetermined distance of the physical address stored in the customer account record.

In another embodiment, an apparatus is described for verifying a location of a security panel installation, comprising a network interface for receiving a security panel identification of a security panel and a physical address where the security panel has been installed, a wireless interface for receiving the security panel identification information of the security panel and a current location of the security panel as determined by location circuitry resident within the security panel, a memory for storing processor-executable instructions for operation of the apparatus and for storing customer account records associated with customers each having an installed security system, and a processor coupled to the network interface, the wireless interface, and the memory, for executing the processor-executable instructions that cause the apparatus to store the security panel identification and the physical address in a customer account record in the memory, compare the current location of the security panel to the physical address stored in the customer account to determine whether the current location of the security panel is within a predetermined distance of the physical address, and generate an indication of the result of the comparison of whether the current location of the security panel is within the predetermined distance of the physical address stored in the customer account record.

In yet another embodiment, a security panel is described, comprising location circuitry for determining a location of the security panel, a wireless interface for transmitting the location of the security panel and a security panel identification to a remote location, a user interface for receiving user input, a memory for storing processor-executable instructions for general operation of the security panel, and a processor, coupled to the location circuitry, the wireless interface, the user interface, and the memory, for executing the processor-executable instructions that cause the security panel to receive a command from the user interface to determine the current location of the security panel, and send the current location of the security panel and a security panel identification to a remote location over a communication channel used to transmit event codes by the security panel.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is an illustration of one embodiment of a home or business security system in communication with a remote monitoring center;

FIG. 2 is a functional block diagram of one embodiment of a server typically used to verify the location of a security panel installation;

FIG. 3 is a functional block diagram of one embodiment of security panel used to verify the location of the security panel; and

FIG. 4 is a flow diagram illustrating one embodiment for verifying a location of a security panel installation.

### DETAILED DESCRIPTION

The present description relates to methods and apparatus for verifying the location of a security panel. Such verifications may be valuable for a variety of reasons, especially in the case of a sale of a security monitoring account from one party to another.

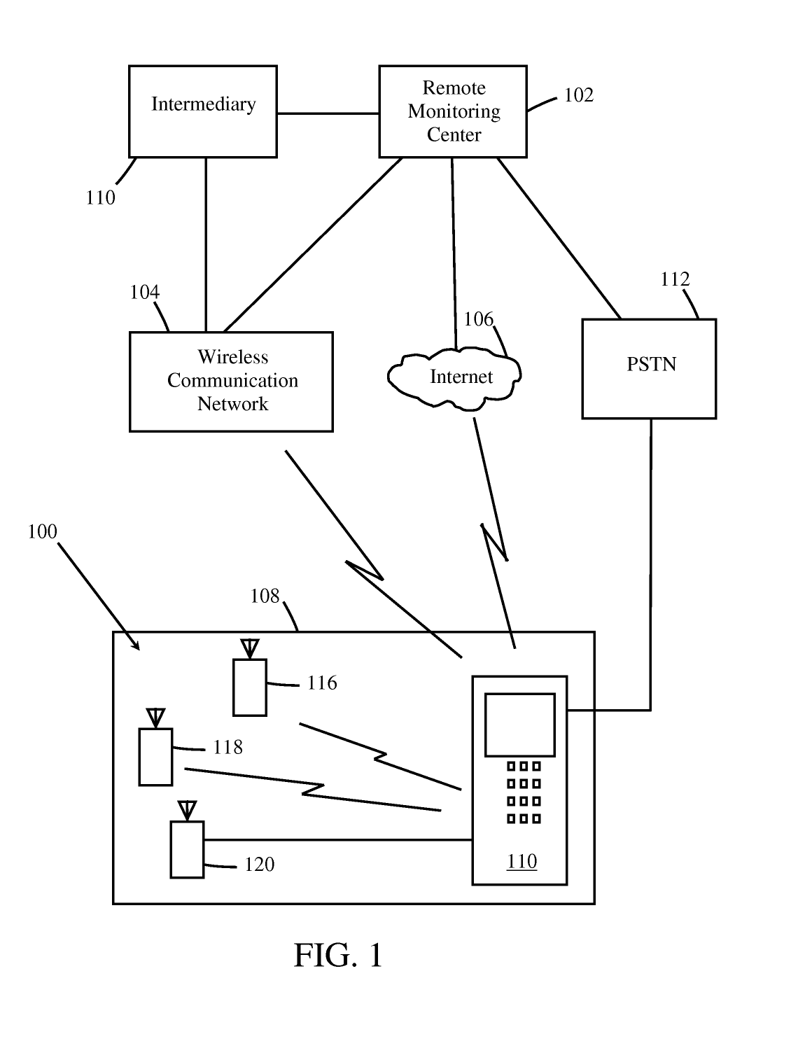

FIG. 1 is an illustration of one embodiment of a home or business security system 100 in communication with a remote monitoring center 102 via wireless communication network 104, wide area network 106, or both. In some embodiments, the security system 100 may additionally be capable of communicating with remote monitoring center 102 via public switched telephone network (PSTN) 112, although for purposes of this disclosure, no further description of this method of communication will be offered.

Security system 100 is typically installed within a home or business, shown as location 108 in FIG. 1. Security system 100 typically comprises a security panel 110 in wired or wireless communication with a number of sensors as shown, for example sensors 116, 118, and 120 distributed throughout location 108. For example, security panel 110 may comprise a L5100 LYNX Touch Wireless Alarm Control Panel, manufactured by Honeywell International, of Morristown, N.J., equipped with an L5100-WIFI LYNX Touch WiFi Alarm Monitoring Communicator, manufactured by Alarmnet, a Honeywell division. The sensors typically comprise a combination of PIR sensors, door/window sensors, and/or tilt sensors, which monitor for various conditions and, in the event that a monitored event is detected, transmit signals to security panel 110 using wired or wireless means well-known to those skilled in the art indicative of the event. Security panel 110, in response, may transmit a message to remote monitoring center 102 where local authorities may be summoned to location 108 to address the event.

Security panel 110 additionally comprises location-determination circuitry for determining a location of security panel 110. The location of security panel 110 may be transmitted along with encoded alarm messages, or it may be transmitted along with a serial number assigned to security panel 110 for location verification purposes, as will be described in greater detail later herein.

Remote monitoring center 102 comprises a communication center staffed with personnel for receiving encoded messages from numerous security panels distributed over a wide geographical area. The encoded messages may be received via data packets transmitted over wide area network 106, such as IP-based data packets, or by DTMF tones received via the public switched telephone network (PSTN) 112. The DTMF tones are generated by security panel 110, which may transmit encoded messages indicative of alarm conditions sensed at location 108 wirelessly over wireless communication network 104 to intermediary 114. Intermediary 114 may be used if remote monitoring center 102 is not capable of receiving wireless signals directly from security panel 110. An example of intermediary 114 is Alarm.com, headquartered in Vienna, Virginia.

Intermediary 114 receives the wireless, encoded messages from security panel 110 via wireless communication network 104 and processes the signals for transmission to remote monitoring center 102 via PSTN 112. Such processing is well-known in the art.

Wide area network 106 comprises a public data network, such as the Internet, that routes data packets from source to destination using protocols such as TCP/IP, FTP, SMTP, etc.

Wireless communication network 104 comprises any variety of cellular communication networks, such as a CDMA or GSM-based wireless communication system. Alternatively, or in addition, wireless communication network may comprise a wireless data network, such as the well-known LTE or WIMAX communication systems.

Security panel 110 may generate messages destined for remote monitoring center using one or more proprietary message protocols such as Contact ID, SIA DC-03 and SIA 2000 protocols. However, an open standard called DC-09 is currently being developed. This standard has been accepted as an American National Standard, and is published as ANSI/SIA DC-09-2007. This protocol provides an encoding scheme and transport mechanism to carry data from 17 previously defined alarm protocols, including the latest Contact ID, SIA DC-03 and SIA 2000 protocols.

Security system 100 may be physically installed by a professional installer or a homeowner. As part of the installation process, an account may be set up with remote monitoring center and/or intermediary 114 prior to activation of the system. Information in the account may be provided to local authorities after an event has been reported by security panel 110, such as a fire, break-in, or medical emergency. For example, an address may be stored in association with a security panel serial number, so that remote monitoring center 102 or intermediary 114 can determine the origin of the encoded message transmitted by security panel 110, and provide the address to authorities.

Determining the location of security panel 110 after installation may be important for a variety of reasons. One reason is for a purchaser of a security monitoring contract to guard against unscrupulous entities who may try to sell such contracts that do not exist. For example, an unscrupulous alarm installation company may claim to have installed over 1,000 security systems, and have 500 security monitoring contracts signed with homeowners associated with the security systems. The alarm installation company typically receives a monthly fee from each customer under contract and may provide monitoring services for customers directly, or may sell the contracts to monitoring service providers such a remote monitoring center 102. A purchaser of such contracts may want to verify that such contracts are bona fide before purchasing them. One way to verify the contracts is to determine an actual location of security panels using position information provided by the panel itself, and compare that location to an address stored in association with each contract or account.

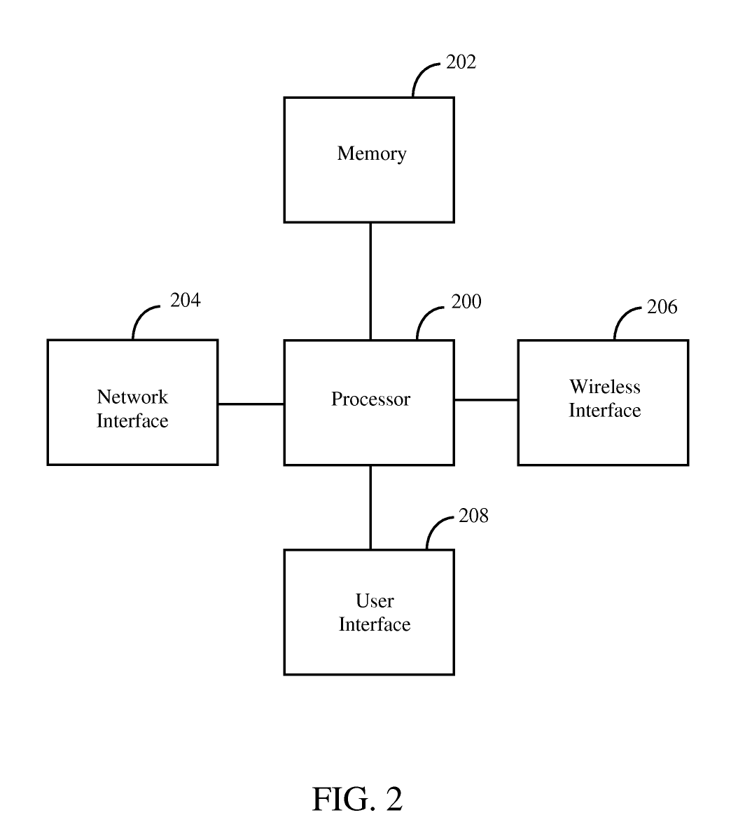

FIG. 2 is a functional block diagram of one embodiment of a server 200 typically managed by intermediary 114 or remote monitoring center 102. Specifically, FIG. 2 shows processor 200, memory 202, network interface 204, wireless interface 206, and user interface 208. It should be understood that not all of the functional blocks shown in FIG. 2 are required for operation of server 200 in all embodiments, that the functional blocks may be connected to one another in a variety of ways, and that not all functional blocks necessary for operation of server 200 are shown for purposes of simplicity and clarity.

Processor 200 is configured to provide general operation of server 200 by executing processor-executable instructions stored in memory 202, for example, executable code. Processor 200 typically comprises a general purpose microprocessor, such as an E5-2600 microprocessor sold by Intel Corporation of Santa Clara, California, although virtually any one of a variety of microprocessors, microcomputers, ASICs and/or microcontrollers may be used alternatively.

Memory 202 comprises one or more information storage devices, such as RAM, ROM, EEPROM, UVPROM, flash memory, CD, DVD, Memory Stick, SD memory, XD memory, thumb drive, or virtually any other type of electronic, optical, or mechanical memory device. Memory 202 is used to store the processor-executable instructions for operation of sever 200 as well as for storing customer account records. Each customer account record is associated with a security system that has been installed into a customer's location. The customer account records typically contain information such as a customer name, customer address, customer telephone number, customer email address, account number, an identification of security system 100 including a make, model and serial number of security panel 110, a make, model, and serial number of the sensors that comprise security system 108, and other information. At least some of the account records additionally contain location information provided by location circuitry associated with each respective security panel 110. This information is typically provided electronically by a security system installer during installation of security system 110 over wide area network 106 using a web application offered by intermediary 114, remote monitoring center 102, or by the installer's employer. The location information is provided after the location circuitry determines a location of a security panel 110 at some point during the installation process, or shortly thereafter.

Network interface 204 comprises hardware and/or software configured to send and receive electronic communications between server 200 and other networked devices, such as a wireless computing device used by an alarm installation technician such as a smart phone or tablet computer, a personal computer, etc. Such communications are sent over one or more communication networks, such as wide-area network 106, fiber optic networks, radio networks, wired or wireless telephone networks, satellite networks, and/or any other well-known, communication networks. Network interface 204 typically comprises circuitry necessary to process the electronic communications and may be designed specifically to communicate using a predetermined communication protocol, such as TCP/IP, RS-485, RS-422, fiber optic protocols, USB protocols, or other well-known form of digital communication protocols.

Wireless interface 206 is electronically coupled to processor 200 and comprises circuitry necessary for receiving information from security panels using well-known wireless protocols, such as any variety of CDMA or GSM. Wireless interface 206 may comprise a single integrated circuit, such as the MB86L10A multi-mode transceiver, manufactured by Fujitsu, of Tokyo, Japan. Another example of Wireless interface 206 is WTR1605 radio frequency IC transceiver, manufactured by Qualcomm Incorporated. Wireless interface 206 may further comprise a multi-mode modem suited for the particular transceiver, such as an MDM9615, also manufactured by Qualcomm Incorporated, which receives intermediate frequency signals from the integrated circuit transceiver, demodulates them, and provides them to processor 200.

User interface 208 comprises hardware and/or software necessary for allowing a user of server 200, such as an authorized technician or service provider, to perform various duties related to the maintenance and upkeep of server 200. User interface 208 may comprise one or more commonly used input and/or output devices, such as keyboards, mouses, touchscreens, video displays, and/or virtually any other device that allows a user of server 200 to enter and retrieve information from server 200.

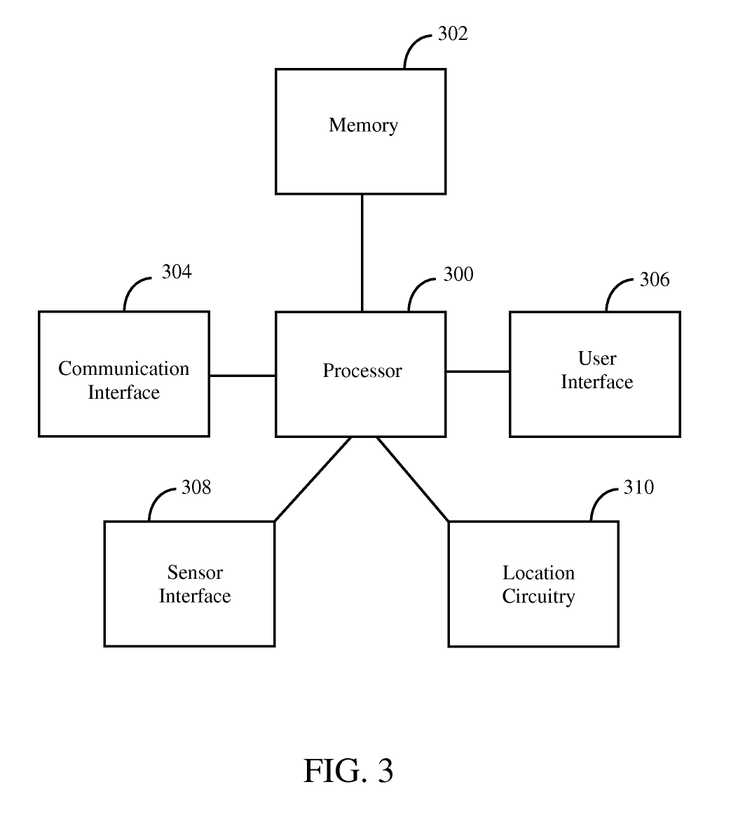

FIG. 3 is a functional block diagram of one embodiment of security panel 110, showing processor 300, memory 302, communication interface 304, user interface 306, sensor interface 308, and location circuitry 310. Security panel 110 typically comprises a residential security panel capable of wireless communications with remote monitoring center 102 or intermediary 114. Such communications typically comprise transmitting alarm “event codes” indicative of events occurring at the premises where security panel 110 is located.

Processor 300 is configured to provide general operation of security panel 210 by executing processor-executable instructions stored in memory 302, for example, executable code. Processor 300 typically comprises a general purpose microprocessor, such as an NUC 710 AND ARM processor manufactured by Nuvoton Technology Corporation of Hsinchu Science and Industrial Park, Taiwan, although virtually any one of a variety of microprocessors, microcomputers, ASICs and/or microcontrollers may be used alternatively.

Memory 302 is coupled to processor 300 and comprises one or more information storage devices, such as RAM, ROM, EEPROM, UVPROM, flash memory, SD memory, XD memory, or virtually any other type of electronic, optical, or mechanical memory device. Memory 202 is used to store the processor-executable instructions for operation of security panel 100 as well as other information, for example, information related to sensors distributed throughout a premises where security panel 110 is located, and contact information related to remote monitoring center 102 or intermediary 114.

Communication interface 304 is coupled to processor 300 and comprises circuitry necessary for security panel 110 to transmit and/or receive information to central monitoring center 102 and/or intermediary 114. In one embodiment, communication interface 304 comprises circuitry necessary for security panel 110 to transmit information, such as event codes, over a wireless communication system, such as any variety of CDMA or GSM cellular communication systems. Such circuitry may comprise one or more of discreet electronic components, a microprocessor, a microcontroller, an ASIC, or other electronic circuitry well-known in the art.

User interface 306 is coupled to processor 302 and allows a user to program and operate security panel 110. User interface 306 may comprise one or more pushbuttons, touchscreen devices, biometric readers, switches, sensors, keypads, and/or microphones that generate electronic signals for use by processor 300 upon initiation by a user. User interface 306 may additionally comprise one or more seven-segment displays, a liquid crystal display (LCD), one or more light emitting diode displays (LEDD), one or more light emitting diodes (LEDs), light arrays, or any other type of visual display. Further, the electronic display could alternatively or in addition comprise an audio device, such as a speaker, for audible presentation of information to a user.

Sensor interface 308 is coupled to processor 302 and allows security panel 110 to communicate with a variety of sensors installed throughout the premises where security panel 110 is located. Sensor interface 308 may comprise circuitry to communicate via wired or wireless means with the sensors. For example, sensor interface may comprise a Max 7044 transmitter and a Max 1473 receiver, both manufactured by Maxim Integrated Products of Sunnyvale, Calif., capable of transmitting and receiving in the 300-450 MHz range. Alternatively, or in addition, sensor interface may comprise circuitry needed to communicate with sensors via a hard-wired connection.

Location circuitry 310 is coupled to processor 300 and provides location information for transmission to a remote location, such as remote monitoring center 102 or intermediary 114. In one embodiment, location circuitry may comprise a GPS chip or module, such as an eRideOPUS 7 GPS receiver manufactured by Furuno Electric Company of Nagasaki, Japan. In other embodiments, other technologies may be used, such as trilateration, which uses cellular signals to determine the location of security panel 110. Location circuitry 310 provides location information of security panel 110 to processor 300 typically in the form of latitude, longitude, and/or elevational coordinates, or some other geographic coordinates such as polar coordinates.

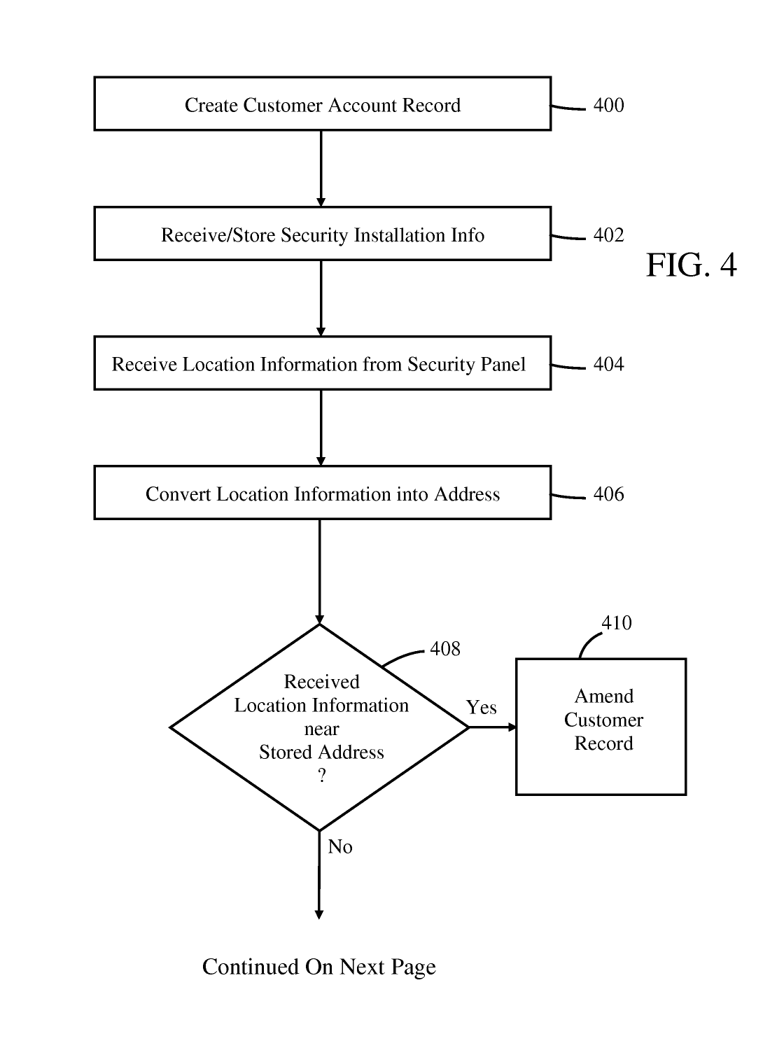

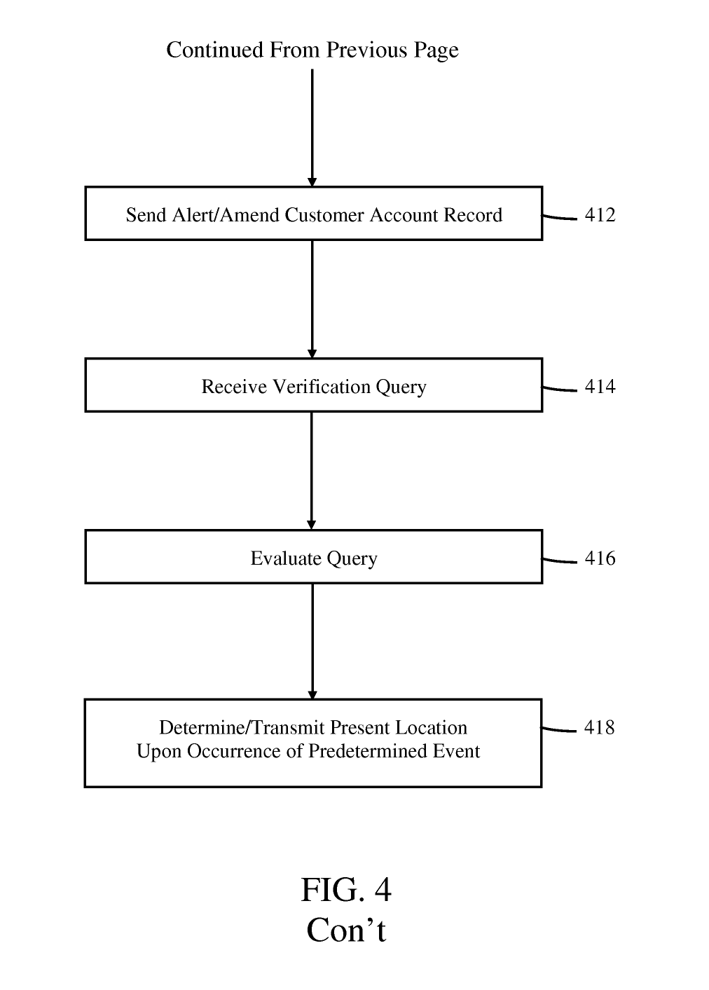

FIG. 4 is a flow diagram illustrating one embodiment for verifying a location of a security panel. The method is implemented by a processor, such as processor 200 shown in FIG. 2 located within server 200, executing processor-executable instructions stored in a memory, such as memory 202. It should be understood that in some embodiments, not all of the steps shown in FIG. 4 are performed and that the order in which the steps are carried out may be different in other embodiments. It should be further understood that some minor method steps have been omitted for purposes of clarity.

At block 400, a customer account record is created and stored in memory 202.

The customer account record may be created by a user of server 200 or remotely by an alarm installation technician during installation of an alarm system at a customer's premises. In this case, the alarm installation technician may use custom software running on a portable computing device in communication with server 200 to instruct processor 200 to create the customer account record.

At block 402, server 200 receives information relating to the particular security system installation, typically provided by the alarm installation technician, such as a physical address where the security system is being installed, a customer name, customer telephone number, customer email address, account number, an identification of security system 100 including a make, model and serial number of security panel 110, a make, model, and serial number of the sensors that comprise security system 108, and other information. Such information is generally provided by the alarm installation technician using a custom software application running on a tablet or mobile computer, smartphone, or the like, over network interface 204 upon initial installation of security system 100, although this information could be provided at any time.

At block 404, server 200 receives location information provided by security panel 110 via the wireless interface 206. This information may be provided at some point during the installation process by the alarm installation technician initiating such a transmission using a user interface on security panel 110. For example, after the alarm installation technician has finished the installing security panel 110 and sensors in a home and configured security panel 110 accordingly, the alarm installation technician might press a series of buttons on a keypad of security panel 110 that causes security panel 110 processor 300 to determine a location of security panel 110 based on information provided by location circuitry 310. Processor 300 then generates a message destined for remote monitoring center 102 or intermediary 114 comprising the location information and transmits it wirelessly over a cellular communication network. The location information may be presented in one or more formats, such as GPS or Polar coordinates, or, in another embodiment, processor 300 may determine a physical address closest to the location information. In this embodiment, memory 302 comprises processor-executable instructions that cause security panel 110 to use the location information to calculate a physical address. For example, the location information typically comprises a latitude, longitude, and elevation, accurate to within just a few meters. Processor 300 may compare this information to mapping information either stored within memory 302, or available to processor 300 via communication interface 304, for example, located at a remote website or database. Based on the comparison, processor 300 determines an address closest to the location information provided by location circuitry 310. The address determined by processor 300 may, alternatively or in addition to the location information, be transmitted to remote monitoring center 102 or intermediary 114.

In any event, the location information is provided from security panel 110 to server 200 using one or move communication channels available to the security panel, which may be different than the communication channel used by the alarm installation technician to send the date mentioned at block 402. Identification information is also transmitted, identifying one or more characteristics of the origin of the location information, such as a serial number of security panel 110, an address where security panel 110 is located, a customer name or other customer identification information, etc. For example, security panel 110 might send the location information using a communication channel normally used to transmit event codes, such as codes representative of smoke or fire detection, break-in, or health emergency reported by one or more of the sensors distributed throughout a home or office. Such a communication channel might comprise a cellular voice channel. Conversely, the alarm installation technician might provide the data mentioned at block 402 over a wireless data network, such as an LTE or WIMAX data network, or over the PSTN.

At block 406, in one embodiment, processor 200 receives the location information and identification information provided by security panel 110 and converts the location information into an address relating to the location information, i.e., an address that is closest to the location information, if it has not already been converted by security panel 110. Memory 202 comprises processor-executable instructions that cause server 200 to use the location information to calculate a physical address that is closest to the location information. For example, the location information typically comprises a latitude, longitude, and elevation, accurate to within just a few meters. Processor 200 may compare this information to mapping information either stored within memory 202, or available to processor 200 via wireless interface 204, for example, located at a remote website or database. Based on the comparison, processor 200 determines an address closest to the location information received from security panel 110.

At block 408, processor 200 compares the location information received at block 406 to an address stored in memory 202 provided by the alarm installation technician at block 402 to verify that security panel 110 is still located where it should be, based on its initial installation. Processor 200 uses the identification information received at block 406 to access a customer account record containing the address provided by the alarm installation technician.

If the address determined by processor 200 at block 408 matches the address stored in the customer account record associated with the identification information received at block 406, processor 200 may amend the customer account record to indicate such a successful comparison, as shown in block 410. Such an amendment may include the time and date that the comparison was made. A match may be determined if the address determined by processor 200 is within a predetermined distance from the address stored in memory 202, as determined by using mapping software and/or mapping information stored in memory 202, or stored remotely and accessible by processor 200 via network interface 206. The predetermined distance may be chosen by processor 200 to reduce the chance of a false result, i.e., a chance that the calculated address by processor 200 is erroneously found to match the address stored in memory 202. For example, the predetermined distance may be selected based on a housing density associated with the location information and provided by mapping software or a web site. Thus, the predetermined distance selected by processor 200 might comprise 500 feet in a rural location, 100 feet in a sub-urban location, and 50 feet in an urban location, as reported at block 406. In another embodiment, the predetermined distance may be set to an accuracy specification of the position location circuitry of security panel 110.

If the address determined by processor 200 at block 408 does not match the address stored in the customer account record associated with the identification information received at block 406, processor 200 may take one or more of the following steps, as shown in block 412: it may amend the customer account record to indicate that the calculated address does not match the address stored in memory 202, it may generate an alert for transmission or presentation to one or more persons that an address mismatch has occurred. Contact information of persons to be contacted in case of a mismatch may be stored in the customer account record, or default contact information may be also stored in memory 202 for whenever a mismatch occurs. The message may comprise a customer name or account number, a date and time that the mismatch occurred, the calculated address, the address stored in memory 202, etc.

At block 414, server 200 may receive a query from a remote location inquiring as to the status of one or more customer accounts. The query may originate from an administrator of server 200, an alarm installation technician, a customer, or a purchaser of one or more alarm contracts to verify that the current location of security panel 110. Thus, the query comprises an identification of a customer and an instruction that directs processor 200 to determine whether a location previously calculated by processor 200 matches either the address stored in the customer account, or an address provided in the query.

At block 416, processor 200 processes the query by accessing the customer account record associated with the customer identified in the query and, in one embodiment, simply provides an indication of whether a location comparison has been performed in the past and if so, the result of the comparison. The date and time of the comparison may also be provided. In another embodiment, processor 200 compares a purported address provided in the query and compares it to the address stored in memory 202 that was calculated by processor 200 at block 406. The results of the comparison are then provided back to the person who submitted the query, possibly including the date and time that processor 200 performed a comparison of location information provided by security panel 110 associated with the customer account and the physical address provided by the alarm installation technician and stored in memory 202.

At block 418, when an predetermined event occurs at the premises where security panel 110 is located, security panel may transmit one or more event codes associated with the event to server 200 over one or more communication channels, such as a cellular voice channel. Processor 200 may, in addition to sending the event code(s), determine a current location of security panel 110 using location circuitry 210, then provide the current location as determined by the location circuitry to server 200 over the same communication channel. In another embodiment, alternative or in addition to the above, the predetermined event comprises an elapse of a predetermined time period from the last time a location was transmitted by security panel 110. In this embodiment, processor 300 at security panel 110 may determine a current location of security panel 110 at predetermined time periods, such as once every day, week, month, or some other time period and provide the location information to server 200 for use in providing updated location information of security panel 110. The predetermined time period may be programmed by the alarm installation technician or any user of security panel 110 and stored in memory 302.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components.

Accordingly, an embodiment of the invention can include a non-transitory, processor-readable media embodying a code or processor-executable instructions to implement the methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. A method for verifying a location of a security panel installation, comprising:
creating a customer account record by a processor in a memory;
receiving a security panel identification of a security panel and a physical address where the security panel has been installed;
storing the physical address and the security panel identification in the customer account record;
receiving a message from the security panel over a communication channel used to transmit alarm event information by the security panel, the message comprising identification information of the security panel sending the message and a current location of the security panel as determined by location circuitry resident within the security panel;
comparing the current location of the security panel to the physical address stored in the customer account by the processor to determine whether the current location of the security panel is within a predetermined distance of the physical address; and
providing an indication of the result of the comparison of whether the current location of the security panel is within the predetermined distance of the physical address stored in the customer account record.

2. The method of claim 1, further comprising:
converting the current location into a current address; and
comparing the current address to the physical address stored in the memory to determine if the security panel is within the predetermined distance from the physical address stored in the customer account record.

3. The method of claim 1, wherein the predetermined distance is a distance within an accuracy specification of position-determination circuitry co-located with the security panel.

4. The method of claim 1, further comprising:
receiving a query from a remote location via a network interface, the query comprising an identification of a customer and a purported address where the security panel is located;
comparing the purported address with the current location of the security panel; and
transmitting a message to the remote location via the network interface of whether the purported address is within a predetermined distance from the current location of the security panel.

5. The method of claim 1, further comprising:
converting the location information into a current address;
storing the current address in the memory;
receiving a query from a remote location via a network interface, the query comprising an identification of the customer and a purported address where the security panel is located;
comparing the purported address with the current address of the security panel; and
transmitting a message to the remote location via the network interface indicative of whether the purported address matches the current address.

6. The method of claim 1, wherein the indication comprises an amendment to the customer account record indicative of the comparison results.

7. The method of claim 1, wherein the indication comprises sending an alert message to one or more persons indicating that the current location of the security panel is not within the predetermined distance of the physical address stored in the customer account record.

8. The method of claim 1, wherein the predetermined distance is selected by the processor based on a housing density associated with the location information.

9. An apparatus for verifying a location of a security panel installation, comprising:
a network interface for receiving a security panel identification of a security panel and a physical address where the security panel has been installed;
a wireless interface for receiving the security panel identification information of the security panel and a current location of the security panel as determined by location circuitry resident within the security panel;
a memory for storing processor-executable instructions for operation of the apparatus and for storing customer account records associated with customers each having an installed security system; and
a processor coupled to the network interface, the wireless interface, and the memory, for executing the processor-executable instructions that cause the apparatus to:
store the security panel identification and the physical address in a customer account record in the memory;
compare the current location of the security panel to the physical address stored in the customer account to determine whether the current location of the security panel is within a predetermined distance of the physical address; and
generate an indication of the result of the comparison of whether the current location of the security panel is within the predetermined distance of the physical address stored in the customer account record.

10. The apparatus of claim 9, wherein the processor-executable instructions comprise further instructions that cause the apparatus to:
convert the current location into a current address; and
compare the current address to the physical address stored in the memory to determine if the security panel is within the predetermined distance from the physical address stored in the customer account record.

11. The apparatus of claim 9, wherein the predetermined distance comprises a distance within an accuracy specification of location circuitry co-located with the security panel.

12. The apparatus of claim 9, wherein the processor-executable instructions comprise further instructions that causes the apparatus to:
receive a query from a remote location via the network interface, the query comprising an identification of a customer and a purported address where the security panel is located;
compare the purported address with the current location of the security panel; and
send a message to the remote location via the network interface indicating whether the purported address is within a predetermined distance from the current location of the security panel.

13. The apparatus of claim 9, wherein the processor-executable instructions comprise further instructions that causes the apparatus to:
convert the location information into a current address;
store the current address in the customer account record;
receive a query from a remote location via the network interface, the query comprising an identification of the customer and a purported address where the security panel is located;
compare the purported address with the current address of the security panel; and
transmit a message to the remote location via the network interface indicative of whether the purported address matches the current address.

14. The apparatus of claim 9, wherein the indication comprises an amendment to the customer account record indicative of the comparison results.

15. The apparatus of claim 9, wherein the indication comprises sending an alert message to one or more persons indicating that the current location of the security panel is not within the predetermined distance of the physical address stored in the customer account record.

16. The apparatus of claim 9, wherein the predetermined distance is selected by the processor based on a housing density associated with the location information.

17. A security panel, comprising:
location circuitry for determining a location of the security panel;
a wireless interface for transmitting the location of the security panel and a security panel identification to a remote location;
a user interface for receiving user input;
a memory for storing processor-executable instructions for general operation of the security panel; and
a processor, coupled to the location circuitry, the wireless interface, the user interface, and the memory, for executing the processor-executable instructions that cause the security panel to:
receive a command from the user interface to determine the current location of the security panel; and
send the current location of the security panel and a security panel identification to a remote location over a communication channel used to transmit event codes by the security panel.

18. The security panel of claim 17, wherein the processor-executable instructions comprise further instructions that cause the security panel to:
determine an address closest to the location information; and
transmit the determined address to the remote location as the location information.

19. The security panel of claim 17, wherein the processor-executable instructions comprise further instructions that cause the security panel to:
determine that a predetermined time period has elapsed from a previous transmission of location information to the remote location;
determine a second location information of the security panel; and
provide the second location as the location information to the remote location.
